(19) United States
(12) Patent Application Publication
(10) Pub. No.: US 2007/0152464 A1
(43) Pub. Date: Jul. 5, 2007

(54) Center console

(75) Inventor: Winfried Moell, Laubach (DE)

Correspondence Address: COHEN, PONTANI, LIEBERMAN & PAVANE, 551 FIFTH AVENUE, SUITE 1210, NEW YORK, NY, 10176, US

(73) Assignee: Siemens Aktiengesellschaft, Munchen (DE)

(21) Appl. No.: 11/602,806

(22) Filed: Nov. 21, 2006

(30) Foreign Application Priority Data
Nov. 24, 2005 (DE) 10 2005 056 306.6

(51) Int. Cl. B60N 3/12

(52) U.S. Cl. 296/37.8

(57) ABSTRACT

The present invention relates to a center console (10) of a motor vehicle, with at least one storage space for receiving objects, with at least one part of the center console (10) being designed as a removable container (12). The container (12) can preferably be slid laterally out of the center console (10) into the leg room on the passenger's side.

The present invention is concerned with a center console of a motor vehicle, with at least one storage space for receiving objects.

Various sizes and embodiments of storage spaces and depositing compartments are used in motor vehicles for diverse purposes, for example for depositing road maps in depositing compartments provided for them in the vehicle doors or as a “glove compartment” for receiving diverse objects. They are generally relatively small or narrow compartments, and so storage spaces are also provided at other points in the motor vehicle for the storage of somewhat larger parts. For example, the tool box or the first-aid box is often stowed in the trunk. However, this has the disadvantage that, particularly in the case of a loaded vehicle, access to the tool box or first-aid box is not always ensured. Then, in the event of a breakdown, under some circumstances the trunk first has to be cleared before the tool is reached.

The object of the present invention is to make optimum use of the construction space in the region of the center console as a storage space.

According to the invention, the object is achieved by a center console of the type described at the beginning, in which at least one part is designed as a removable container.

The advantage of the center console according to the invention is that the removable container makes additional, voluminous storage space available in the interior of a motor vehicle. Removal of a container makes it possible to optimally use the construction space which is present in the region of the center console and, because of its geometrical arrangement, is not usable with customary solutions, for example because of a shift lever situated in front of it.

The container can preferably be removed laterally from the center console. This makes it possible also to use, as storage space, that region of the center console where access from the front is impossible or is only possible to a very limited extent, for example because of a shift lever arranged in front of it.

An embodiment is particularly preferred, in which the container can be slid out of the center console into the leg room on the passenger's side. The container is therefore preferably arranged in the lower region of the center console. The displaceable arrangement provides a container which is capable of using the entire width of the construction space of the center console, i.e. the entire depth with respect to the sliding direction. The container can be formed with simple guide profiles or else with a sliding mechanism using rails and sliding elements. For improved operating comfort, the mechanism can additionally be realized with damping elements and/or opening and closing drives.

In an expedient embodiment, the container has shelves and/or subdivisions in order better to be able to stow objects of differing type and size. This can also be supplemented by the container having receiving devices for receiving different objects.

A refinement is particularly preferred, in which a tool kit and/or first-aid utensils can be stowed in the container in order to have them easily accessible at all times in the vehicle interior. In particular in the case of vehicles which are used as utility vehicles and/or recreational vehicles, for example in the case of off-road vehicles, pickup trucks, etc., it is often highly necessary to have a tool or dressing material rapidly available. Depending on requirements, the container may be constructed in such a manner that it can be completely removed from the center console and, in addition, has handle devices in order also to be available outside the vehicle as an independent tool box.

In a practical development of the invention, it is provided that the removable container has at least one separately removable insert for receiving objects. For example, relatively small objects used more frequently, such as, for example, pens or else small change, can be accommodated therein.

In a particularly user-friendly embodiment, the insert can be slid out of the container, so that the insert is accessible without having to open the entire container.

In a preferred embodiment, a locking device is provided, with which the container can be locked in the closed state in order also to be able to use the container to securely store valuable objects.

Of course, a plurality of laterally removable containers may also be provided in the region of the center console. It goes without saying that the number and the size of the containers depends on the construction space available and also on the leg room which is available and into which the container or containers are moved when they are opened.

An exemplary embodiment of the invention is discussed in more detail below with reference to the attached drawings, in which:

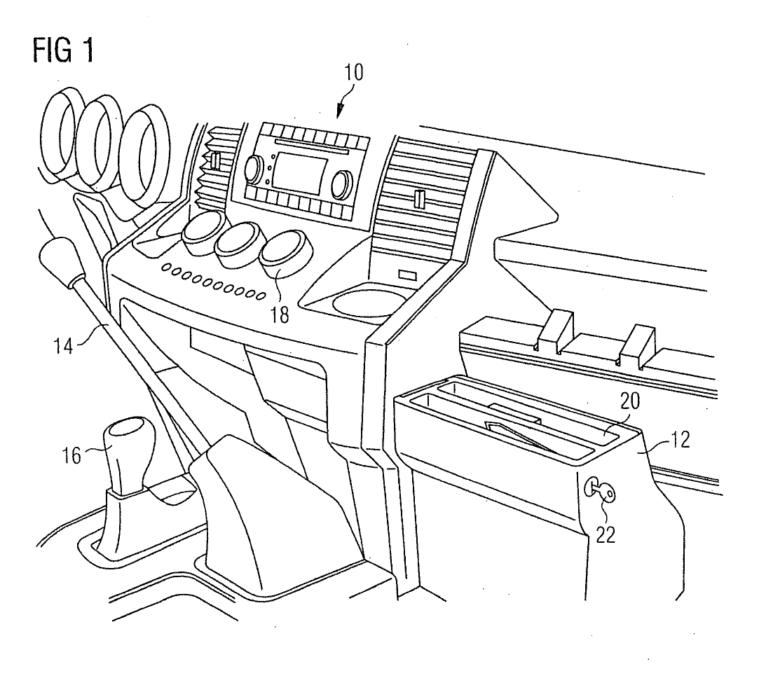

FIG. 1 shows a perspective oblique view of a center console of a vehicle with a container partially slid out;

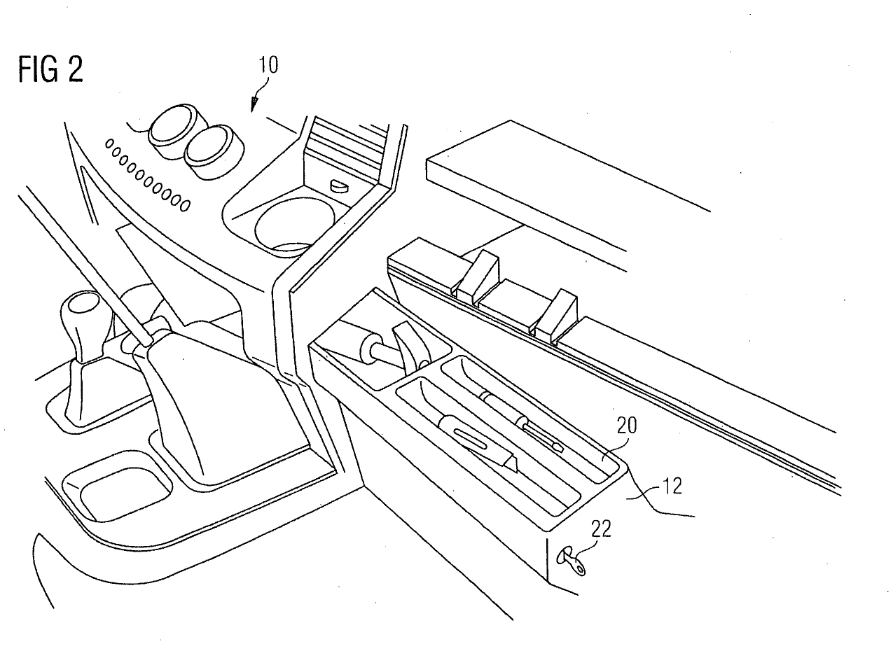

FIG. 2 shows a center console, in which the container according to FIG. 1 is slid out somewhat further, and

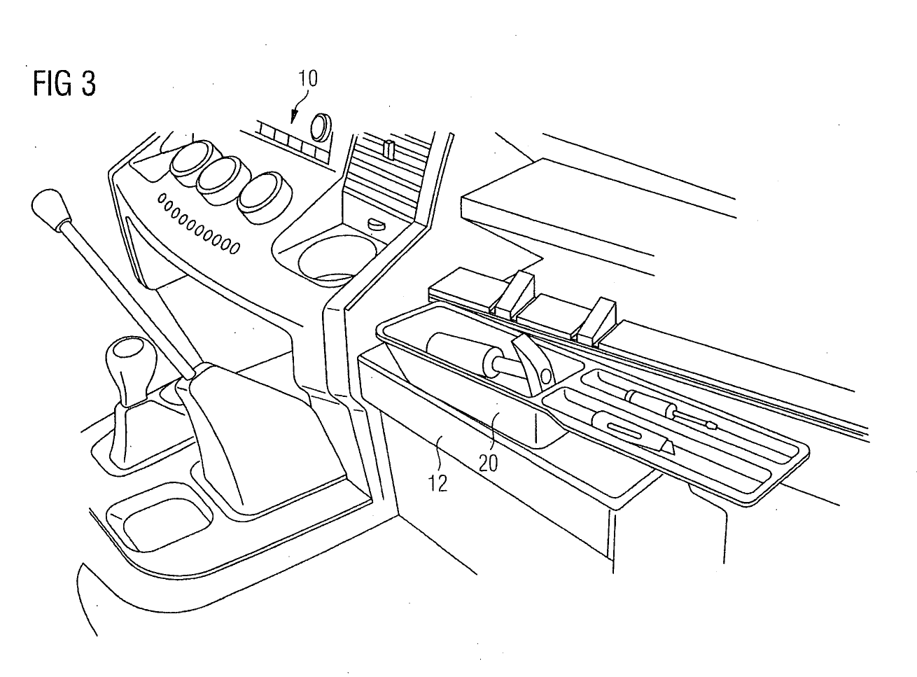

FIG. 3 shows a center console, in which the container according to FIGS. 1 and 2 is slid out and a removable insert is raised somewhat.

FIG. 1 illustrates a perspective oblique view of a center console 10 of a vehicle with a container 12 which is partially slid out. The container 12 is situated in the lower region of the center console 10 and can be slid out of the center console 10 into the leg room on the passenger's side.

The container 12 is arranged in that region of the center console 10 which, although appropriate as a storage space, has situated in front of it a shift lever 14 for a transmission and a shift lever 16 for an all-wheel drive, making it difficult or impossible to access the container 12 from the front. The shape of the container 12 is matched to the available construction space of the center console 10. Diverse operating and control elements 18 of the vehicle are situated above that region of the center console 10 into which the container 12 can be pushed. In FIG. 2, the container 12 is slid out somewhat further from the center console 10.

In FIG. 3, the container 12 is in a maximum opening position. However, it is only slid out of the center console 10 to the extent that it is still held at its one end in the side wall of the center console 10. It can be prevented from being unintentionally slid out completely by means of a stop (not shown). The container 12 can also be formed with a slightly modified stop in such a manner that it can be completely removed from the center console 10. For this purpose, use may be made, for example, of a releasable stop or of a stop which is to be overcome by a somewhat higher force.

The container 12 has a removable insert 20 which is raised somewhat in FIG. 3. The removable insert 20 serves to receive relatively small objects, such as, for example, pens or a tool.

The container 12 may be equipped with shelves (not illustrated) and/or subdivisions depending on the intended use. Similarly, receiving devices for receiving different objects may be provided, for example for bottle-like vessels.

The insert 20 may also be designed such that it can be slid out and, when the need arises, may have one or more shelves and/or one or more subdivisions.

A locking device 22 is provided on the container 12. In the closed state, the container 12 with the insert 20 inserted can be locked by said locking device, thus making access no longer possible. As a result, the container 12 is also suitable for storing valuable objects.

A tool kit and/or first-aid utensils can preferably be stowed in the container 12, which is appropriate in particular in the case of vehicles which have an open loading area and do not have a trunk or separate storage space. The tool and/or the first-aid utensils are accommodated in the container 12 at a secure, easily accessible and protected point. In the case of vehicles with a trunk, the objects stowed in the container 12 are in addition easily accessible even if the vehicle is heavily loaded, whereas, if they were accommodated in the trunk, the latter would first of all have to be partially unloaded again in order to reach the tool or the first-aid box.

The container 12 may be provided with additional handle elements, so that it may be removed from the vehicle as a separate tool box. The center console according to the invention is thus suitable in particular for recreational vehicles and utility vehicles, for example for all-terrain vehicles and pickup trucks.

1-11. (canceled)

12. A center console of a motor vehicle, comprising a removable container defining a storage space for receiving objects to be stored, said container being removably arranged at a region in said center console, wherein access to said region from a front side of the center console is at least partially obstructed.

13. The center console of claim 12, wherein said container is laterally removable from said center console.

14. The center console of claim 13, wherein said container is slidably arranged in said center console so that said container slidably laterally removable from said center console into a passenger side leg room space in the motor vehicle.

15. The center console of claim 13, wherein said container is arranged in a lower region of said center console.

16. The center console of claim 12, wherein said container has at least one of shelves and subdivisions.

17. The center console of claim 12, wherein said container has storage devices for receiving different objects.

18. The center console of claim 12, wherein said container stows at least one of a tool kit and a first-aid kit.

19. The center console of claim 12, wherein said container has at least one removable insert for receiving objects.

20. The center console of claim 19, wherein said insert is slidable or liftable out of said container.

21. The center console of claim 19, wherein said insert has at least one of shelves and subdivisions.

22. The center console of claim 12, further comprising a locking device for locking said container in said center console when said container is fully inserted in said center console.
